(19) United States
(12) Patent Application Publication
(10) Pub. No.: US 2004/0255098 A1
(43) Pub. Date: Dec. 16, 2004

(54) Processor having register renaming function

(75) Inventors: Yoshikazu Ogawa, Kanagawa (JP); Harutaka Goto, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/812,886

(22) Filed: Mar. 31, 2004

(30) Foreign Application Priority Data
Mar. 31, 2003 (JP) 2003-096751

(51) Int. Cl. G06F 9/30

(52) U.S. Cl. 712/217

(57) ABSTRACT

A processor with a register renaming function comprises: an instruction fetch; a decoder for an instruction code of a fetched instruction; a register holding data corresponding to a register number; a register body holding data corresponding to a register number; a caching register to cache the contents in the body; an inner instruction information holder (IIIH) to hold information on a state of an inner instruction including a logical register number and a caching register number of the caching register by the fetched instruction; an instruction insertion determiner (IID) to compare an instruction code by pre-decoding the fetched instruction with information on a state of the inner instruction of IIIH to determine the inner instruction; and a register transfer instruction issuer for transferring inner data between the caching register and the body when the IID determines the inner transfer instruction is to be inserted.

### CROSS REFERENCE TO RELATED APPLICATION

This application claims benefit of priority UNDER 35 USC §119 to Japanese Patent Application No. 2003-96751, filed on Mar. 31, 2003, and the entire contents of which are incorporated by references herein.

### BACKGROUND OF THE INVENTION

The present invention relates generally to a microprocessor having the register renaming function.

The performance of a typical microprocessor is enhanced by executing an out-of-order and incorporating complicated functions, such as a register renaming function. The register renaming (register name changing) function is the function of having a physical register which can not be referred on a program in order to removing a hazard (fault, accident), which is caused by register writing, such as WAR and WAW, by previously preparing a duplication of a register.

In this register renaming processing, a construction represented by, e.g., a processor, identifies a register buffer to control a complicated renaming processing by comparing a register number so that a logical register capable of being referred on a physical register and a program is appropriately assigned.

If a plurality of threads are simultaneously executed in a processor like a simultaneous multi-threading (SMT), the above described register renaming function has the same number of constructions as the number of executions (see “Compaq Choose SMT for alpha” written by Keith Diefendorff, Cahners Microprocessor report, Dec. 6, 1999, Vol.13, No. 16, pp5-7). Therefore, if the number of logical registers increases, the complexity of the construction of the whole microprocessor increases. The “thread” herein means a logical route or thread for executing a logical operation.

On the other hand, with enhancement of software technology, it has been possible to improve performance by optimizing a program by enhancing the flexibility of register assignment. For example, as a method for realizing a multi-task processing, a multi-threading will be considered. If the grading of a processing is decreased to carry out threading, the number of registers required in the processing is small. However, the threading is carried out at an excessively fine grading, an overhead (a state exceeding the limit), such as the switching of processing between threads, appears, so that there are some cases where it is not possible to obtain effects due to threading.

The grading of a processing cannot be simply divided, and there are some cases where the grading is large to some extent for convenience of optimization of the processing in accordance with the contents of the processing. In this case, if the grading increases, the processing carried out by one thread is complicated, and the number of assigned registers increases. As described above, although the increase of the number of registers has the advantage of improving the processing performance by software, it has the disadvantage of increasing complexity on the configuration of hardware.

There will be described an example of a construction of a microprocessor of a conventional superscalar system shown in “The MIPS 10000 Superscalar Microprocessor” written by Kenneth C. Yeager, IEEEMicro, April 1996, pp28-33. This comprises an instruction fetch for fetching an instruction from a memory, an instruction decode for decoding an instruction code fetched by the instruction fetching part, a central window for temporarily holding a register number by a code from the instruction decoding part, a register, a reorder buffer, an arithmetic logic unit (ALU), a store unit, a load unit, and a data cache memory. For convenience of simple explanation, the above construction describes only the relationship in connection between data paths. Since basic components of this construction correspond to those shown in FIG. 2, refer to FIG. 2.

The central window issues an issue-able instruction on the basis of operation end information of a physical register, which is an object, from the reorder buffer, and supplies data of a renamed physical register from the register to the ALU, store unit and load unit, to execute an operation out of order. The result of the operation is fed to are order buffer to obtain the result corresponding to a logical register number in order.

FIG. 8 shows an example of a register renaming function which is important to the superscalar system. Referring to FIG. 8, the operation will be described in more detail below. The register renaming function comprises a reorder buffer 2040, a physical register 2010, a physical register free list 2020, and a register alias table 2030. It is assumed that the physical register free list 2020 and the register alias table 2030 are incorporated in the instruction decode in the above construction. The reorder buffer 2040 is obtained by showing the reorder buffer in the above construction in more detail, and comprises instruction numbers, completion bits, logical register numbers, and old physical register numbers.

In the register renaming system, a larger number of physical registers than the number of logical registers exist. When an instruction is fetched to carryout decoding, a physical number, in which the results of the instruction are actually stored, is assigned to a logical register number assigned by a destination of an instruction code. The assignment is shown by the register alias table 2030. The assignment of the physical register number is read out of a register number list of the physical register free list 2020. In the reorder buffer 2040, instructions are stored in order of instruction fetch while assigning instruction numbers. The reorder buffer 2040 can end the subsequent instructions if only all of the preceding instructions end to leave the reorder buffer.

It is assumed that, after three instructions to which instruction numbers 1, 2 and 3 are assigned are issued, the reorder buffer 2040 holds the instructions while the instructions are not ended, and that the instruction of instruction number 3 is a branch instruction. The instruction is executed (busy) when the completion bit of the reorder buffer 2040 is “1”, and the execution of the instruction is completed when it is “0”. As shown by the completion bit, the flow of operation of the register renaming function from a status that an instruction 4 is fetched and issued, in a state that only the execution of an instruction of instruction number 2 is completed, will be described below.

It is assumed that the instruction 4 uses a logical register number 2 as a destination. At that time, a physical register number 3 is received from the physical register free list 2020 via a signal line 1001 to rewrite the physical number 0 of the register alias table 2030 to 3 to write the previous physical register number in an old physical register number column of the reorder buffer 2040 via a signal line 1003. Then, the execution of the instruction of instruction number 1 is completed, the corresponding completion bit is “0”, and the logical register number R1 is in order that the previous instruction does not have non-end instructions, the value thereof being stored in a physical register number 10 corresponding to the logical register number R1 shown in the register alias table 2030.

The old physical register number 20 corresponding to the instruction number 1 of the reorder buffer 2040 denotes a physical register number that writing is carried out in the logical register R1 by an instruction before the instruction number 1. The physical register number 10 corresponds to R1, so that the old physical register number 20 is registered in the physical register free list 2020 via a signal line 1004. The physical register free list 2020 has a first in first out (FIFO) structure, and the assignment of physical register numbers in the register alias table 2030 is carried out in order of registration. When the instruction 1 ends, the execution of the instruction 2 has been already ended. Therefore, it leaves the reorder buffer 2040, and the old physical register number is registered in the physical register free list 2020 via the signal line 1004 similar to the instruction 1. In the physical register numbers 10 and 0, the values of the logical registers R1 and R2 are stored in order.

If the instruction 4 ends before the instruction 3, the results thereof is stored in the physical register number 3 with respect to the logical register R2, and stored in a register indicated by a signal line 1005. Since the instruction does not end, the value of the register indicated by the signal line 1005 is in a foresight state.

If the forecasting of branch is erroneously carried out in the execution of a branch instruction of the instruction 3, the result of the instruction 4 is canceled. In that case, the physical register number of the corresponding register alias table 2030 in the logical register R2 shown by an item of the instruction 4 of the reorder buffer 2040 is rewritten to be the old physical register number 0 of the instruction 4 of the reorder buffer 2040, and the item of the instruction 4 of the reorder buffer 2040 is deleted.

Therefore, the logical register R2 is caused to correspond to the physical register 0 which stores therein the results of operation of the instruction 2, which is the last instruction for rewriting the register R2. The physical register 3 is rewritten in the physical register free list 2020.

All writing is carried out by a physical register number corresponding to a logical register via the register alias table 2030. After it is confirmed whethera register number to be read has been stored (entered) in the reorder buffer 2040, if it has not been entered, the read-out of a value is carried out by a physical register number corresponding to a logical register via the register alias table 2030.

If the register number to be read has been entered, it is confirmed that execution of an instruction depending on a completion bit field of the reorder buffer 2040 is completed, and the read-out of a value is carried out by a physical register number corresponding to a logical register via the register alias table 2030. The register renaming function is realized by such a complicated construction, and the register alias table 2030 and the order buffer 2040 exchange data indicative of a logical register number by an association system.

Therefore, the logical register number increases, the size of the register alias table 2030 increases, so that it is required to increase the size of the physical register free list 2020. In addition, the size of a field of a logical register number of the reorder buffer 2040 increases. As a result, if the configuration of the register renaming function is more complicated and if increment is carried out, there is some possibility that a critical path is caused to be formed with respect to a working speed to form a bottleneck to realize a target working speed.

FIG. 9 shows an example of a configuration of a simultaneous multi-threading processor capable of simultaneously executing two threads. For convenience of explanation, a physical register 3400 and a physical register 3700 are shown so as to be divided by operations of register read and register write. However, their substance is one register, and corresponds to the physical register 2010 shown in FIG. 9. In order to allow program A and program B, which do not mutually depend on each other, to be simultaneously executed, an instruction fetch unit 3100 comprises two program counters 3100 and 3120 and an instruction queue 3130. The instruction fetch carries out fetch while alternating an access right in the program counters 3100 and 3120 every one cycle.

If a fetch can not be carried out by an instruction fetch corresponding to one program counter due to a cache error or the like, an instruction fetch can be sequentially carried out by the other program counter. With respect to instructions stored in the instruction queue 3130, corresponding instructions are assigned to the register alias tables 3210 and 3220 provided in the decoder 3200, and physical register numbers corresponding to logical register numbers are assigned thereto.

It is assumed that the register alias table 3210 corresponds to the program counter 3100 and the register alias table 3220 corresponds to the program counter 3120. Instruction codes decoded by the decoder 3200 are stored in the concentrated window 3300 to read data necessary for operation from the physical register 3400, so that simultaneously executable instructions are inputted to an execution unit 3500. The results of operation of the execution unit 3500 are written in a physical register of a number corresponding to a logical register number indicated in the physical register 3700 by the register alias tables 3210 and 3220, and the results of operation are defined by a reorder buffer 3800 in order of instruction fetch.

The reorder buffer 3800 comprises two reorder buffers 3810 and 3820. The reorder buffer 3810 corresponds to the register alias table 3210, and the reorder buffer 3820 corresponds to the register alias table 3220. These buffers are separately operated. That is, in the simultaneous multi-threading processor capable of simultaneously executing two threads, two register renaming functions exists in an independent state. In the case of a simultaneous multi-threading processor capable of simultaneously executing n threads, n program counters and n sets of register renaming functions exist. Therefore, the simultaneous multi-threading processor has the same influence of the bottleneck due to the construction of the register renaming function with the increase of the number of logical registers described in FIG. 9.

Therefore, it is necessary to provide a caching register to realize the consistency between the caching register and a resister body by the same construction as a conventional construction with respect to a complicated control, such as an out-of-order execution, by inserting and executing an instruction for loading or storing register data in accordance with a register of the subsequent instruction and caching information, even if the number of logical registers capable of being referred on a program.

### SUMMARY OF THE INVENTION

According to a first aspect of the present invention, a processor having a register renaming function, comprises: an instruction fetch part configured to fetch an instruction; a decoding part configured to decode an instruction code from the instruction fetched by the instruction fetch part; a register part configured to hold data corresponding to a register number indicated by the instruction code decoded by the decoding part; a register body configured to hold data corresponding to a register number indicated by said instruction code; a caching register configured to cache the contents held by said register body; an inner instruction information holding part configured to hold information on a state of an inner instruction including a logical register number and a caching register number, which are held by said caching register by an instruction from said instruction fetch part; an instruction insertion determining part configured to compare an instruction code, which is obtained by pre-decoding the instruction from said instruction fetch part, with information on a state of the inner instruction, which is held by said inner instruction information holding part, to determine whether the inner instruction is to be inserted; and a register transfer instruction issuing part configured to issue a register transfer instruction for transferring inner data between said caching register and said register body when said instruction insertion determining part determines that the inner transfer instruction is to be inserted, thereby the processor having a register renaming function for sequentially rewriting the contents of a register alias table using a reorder buffer and a physical register free list, said reorder buffer holding a correspondence of a logical register number to its physical register number, which are included in the decoded instruction code, in a register alias table and storing an assignable number of the physical register number in the physical register free list to store a correspondence of an instruction number, an architecture register number and an old physical register number.

According to a second aspect of the present invention, a processor having a register renaming function, comprises: an instruction fetch part configured to fetch an instruction; a decoding part configured to decode an instruction code from the instruction fetched by the instruction fetch part; a register part configured to hold data corresponding to a register number indicated by the instruction code decoded by the decoding part; a register body configured to hold data corresponding to a register number indicated by said instruction code, and including a logical register capable of being referred on a program; a caching register configured to cache the contents held by said register body, and including an inner register configured to hold a part of said logical register; an inner instruction information holding part configured to hold information on a state of an inner instruction including a logical register number and a caching register number, which are held by said caching register by an instruction from said instruction fetch part; an instruction insertion determining part configured to compare an instruction code, which is obtained by pre-decoding the instruction from said instruction fetch part, with information on a state of the inner instruction, which is held by said inner instruction information holding part, to determine whether the inner instruction is to be inserted; and a register transfer instruction issuing part configured to issue a register transfer instruction for transferring inner data between said caching register and said register body when said instruction insertion determining part determines that the inner transfer instruction is to be inserted, and comprising a converting part configured to convert it into an inner register number, which is used by said logical register and said inner register, and a code producing part configured to produce a code in the same form as that of a processor inner instruction code for transferring data between said logical register and said inner register, thereby the processor having a register renaming function for sequentially rewriting the contents of a register alias table using a reorder buffer and a physical register free list, said reorder buffer holding a correspondence of a logical register number to its physical register number, which are included in the decoded instruction code, in a register alias table and storing an assignable number of the physical register number in the physical register free list to store a correspondence of an instruction number, an architecture register number and an old physical register number.

According to a third aspect of the present invention, a processor having a register renaming function, comprises: an instruction fetch part configured to fetch an instruction; a decoding part configured to decode an instruction code from the instruction fetched by the instruction fetch part; a register part configured to hold data corresponding to a register number indicated by the instruction code decoded by the decoding part; a register body configured to hold data corresponding to a register number indicated by said instruction code; a caching register configured to cache the contents held by said register body; an inner instruction information holding part configured to hold information on a state of an inner instruction including a logical register number and a caching register number, which are held by said caching register by an instruction from said instruction fetch part; an instruction insertion determining part configured to compare an instruction code, which is obtained by pre-decoding the instruction from said instruction fetch part, with information on a state of the inner instruction, which is held by said inner instruction information holding part, to determine whether the inner instruction is to be inserted; a register transfer instruction issuing part configured to issue a register transfer instruction for transferring inner data between said caching register and said register body when said instruction insertion determining part determines that the inner transfer instruction is to be inserted; and a pre-decoding part configured to pre-decode an instruction from said instruction fetch part to an instruction code, thereby the processor having a register renaming function for sequentially rewriting the contents of a register alias table using a reorder buffer and a physical register free list, said reorder buffer holding a correspondence of a logical register number to its physical register number, which are included in the decoded instruction code, in a register alias table and storing an assignable number of the physical register number in the physical register free list to store a correspondence of an instruction number, an architecture register number and an old physical register number.

### BRIEF DESCRIPTION OF THE DRAWINGS

In the drawings:

FIG. 1 is a block diagram showing the construction of the first embodiment of a microprocessor as a basic concept of the present invention;

FIG. 2 is a functional block diagram showing the construction of the second embodiment of a microprocessor having a register file according to the present invention;

FIG. 3 is an illustration showing the detailed construction of a TAG 110 in FIG. 2;

FIG. 4 is a flow chart showing a control flow in the TAG 100 of FIG. 2;

FIG. 5 is an illustration showing the construction of a register renaming function in an example of the second embodiment of a microprocessor having a register file according to the present invention;

FIG. 6 is a functional block diagram showing an example of a construction in the second embodiment of a simultaneous multi-threading microprocessor according to the present invention;

FIG. 7 is a block diagram showing a load/store register instruction inserting unit of the third embodiment of a microprocessor according to the present invention as a construction of the control flow of FIG. 4;

FIG. 8 is an illustration showing an example of a construction of a register renaming function of the conventional micro processor; and

FIG. 9 is a function block diagram showing an example of a construction of a simultaneous multi-threading microprocessor.

### DESCRIPTION OF THE EMBODIMENTS

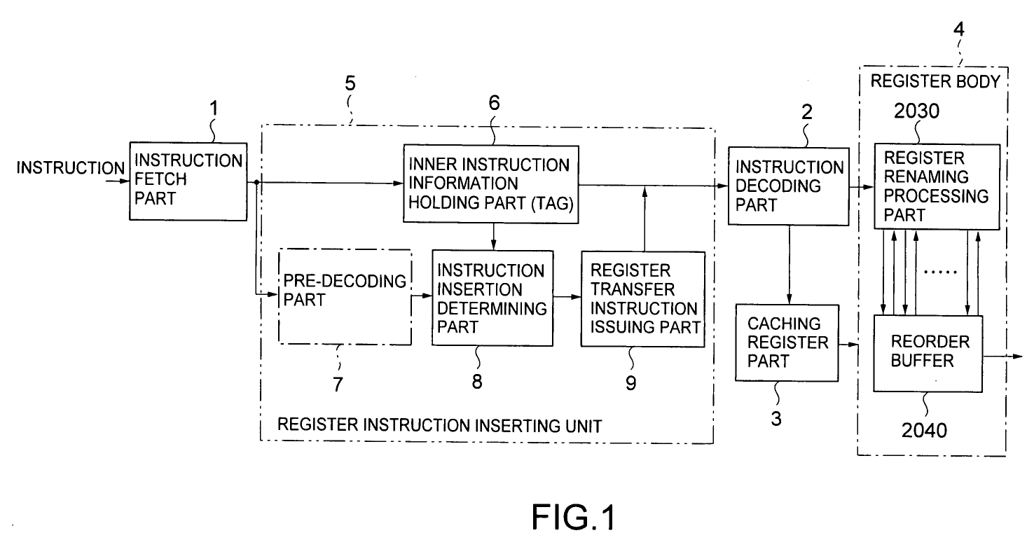

Referring now to the accompanying drawings, the embodiment of a microprocessor having a register renaming function according to the present invention will be described below in detail. First, referring to FIG. 1, the first embodiment of a processor including a basic principle of the present invention will be described below.

As shown in FIG. 1, a processor in the first embodiment comprises an instruction fetch part 1 for fetching an instruction, an instruction decoding part 2 for decoding an instruction code from the instruction fetched by the instruction fetch part 1, and a caching register part 3 for holding the instruction code decoded by the instruction decoding part 2.

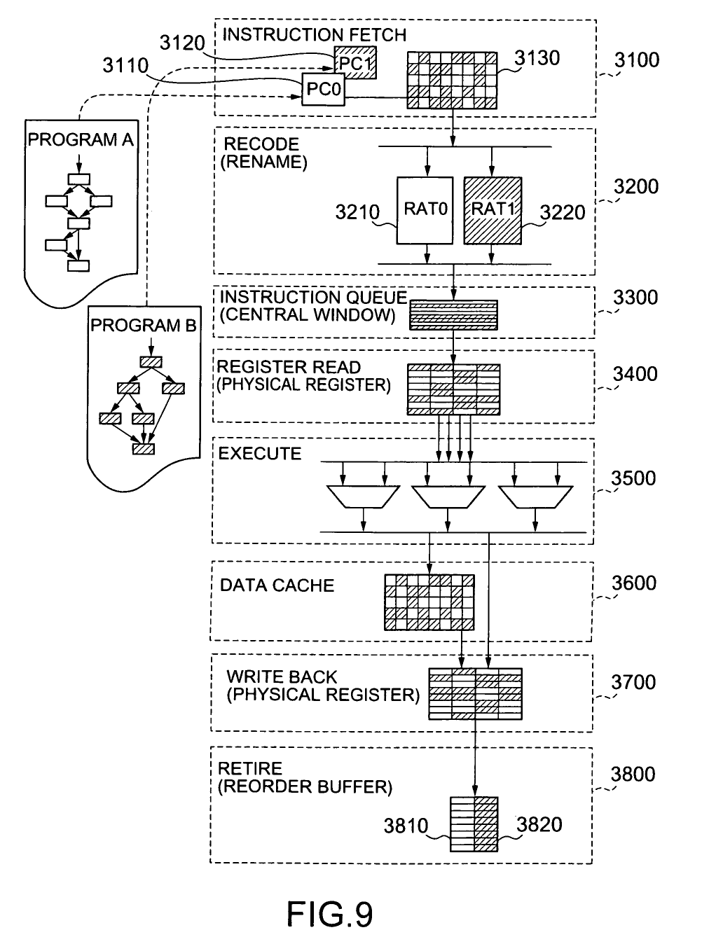

The processor in the first embodiment also has a reorder buffer 2040 for holding the correspondence of a physical register number, which is included in the decoded instruction code, to an instruction, which is included in a physical register of the physical register number, in a register alias table and for storing the assignment of the physical register number in a physical register free list to store the relationship between an instruction number, a processing state, an architecture register number and an old physical register number, and a resister renaming processing part 2030 for sequentially rewriting the contents of the register alias table using the physical register free list. Since the function of the register renaming processing part 2030 using the reorder buffer 2040 is substantially the same as the conventional function described referring to FIG. 9, the duplicated explanation thereof is omitted, and it will be described in more detail in the description of the second embodiment.

The processor with such a basic construction has a register body 4 for holding the instruction code, a caching register part 3 for caching the contents held by the register body 4, and a register instruction inserting unit 5 for inserting a register instruction.

The register instruction inserting unit 5 comprises: an inner instruction information holding part 6 for holding information relating to the state of an inner instruction including a logical register number and a caching register number which are held by the caching register 4 by the instruction from the instruction fetch part 1; a pre-decoding part 7 for pre-decoding the instruction from the instruction fetch part; an instruction insertion determining part 8 for comparing an instruction code, which is pre-decoded by the pre-decoding part 7, with information relating to the state of the inner instruction, which is held by the inner instruction information holding part 6, to determine whether the inner instruction is to be inserted; and a register transfer instruction issuing part 9 for issuing a register transfer instruction for transferring inner data between the caching register 4 and the register body 3 when the instruction insertion determining part 8 determines that the inner transfer instruction is to be inserted.

According to the above described processor in the first embodiment, the caching register 4 is provided for allowing the consistency between the caching register part 3 and the resister body 4 with the same construction as a conventional construction with respect to a complicated control, such as an out-of-order execution, by inserting and executing an instruction for loading or storing register data by the register instruction inserting unit 5 in accordance with a register of the subsequent instruction and caching information, even if the number of logical registers capable of being referred on a program.

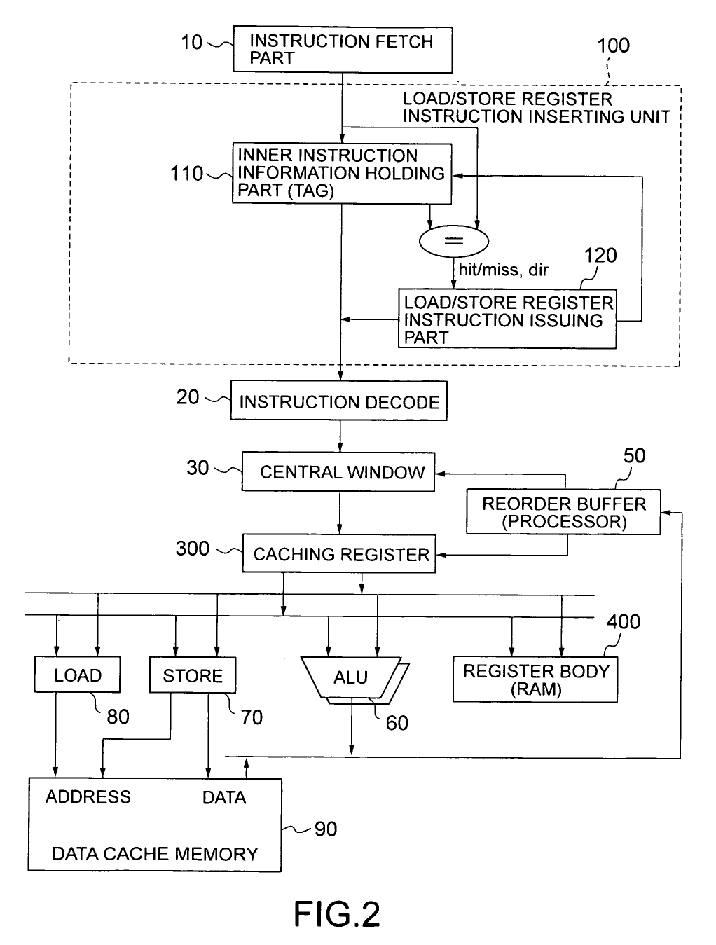

Referring to FIGS. 2 through 6, the second embodiment of a process or having a register renaming function according to the present invention will be described below. In the processor in the second embodiment, the operation of the register body 3 and caching register 4 will be described in more detail.

With the improvement of software technology, even if a program can be independently as a multi-stream, the minimum unit of the program is always instructed and executed in accordance with the results of processing based on the last instruction due to characteristics of the program. This means that locality is caused in a logical register to be used.

Since locality exists in the logical register to be used, if part of the whole logical register is cached and if control, such as register renaming, is carried out with respect to only the cached register, the complexity of hardware construction with the increase of the number of logical registers is relieved. However, if it is constructed as a usual data cache, when cache is carried out by mistake, it is required to carry out a re-fill processing, so that a pipeline stalls for a long period of time by the re-fill processing to deteriorate performance.

FIG. 2 shows the construction of a processor having a caching function of a register file, which can also avoid the above described problem. In FIG. 2, it is assumed that components as the same name as those in the conventional construction, have the same or similar functions, and duplicated explanation is omitted. In the second embodiment of a processor according to the present invention, the register of the conventional construction is installed as a RAM 400 to be used as the body of the register, and a caching register 300 is arranged below the central window 30. The caching register 300 exchanges data from and to the RAM 400 by an instruction supplied from a load/store register instruction inserting unit 100. The same data transfer operation as the load/store instruction to the data cache memory 90 is carried out.

The load/store register instruction inserting unit 100 comprises a TAG 110 and a load/store register instruction issuing part 120. The TAG 110 is arranged below the instruction fetch for controlling the insertion of an instruction into the load/store register instruction issuing unit 120 by source register numbers Rs, Rt and destination register number Rd of an instruction code supplied from the instruction fetch 10.

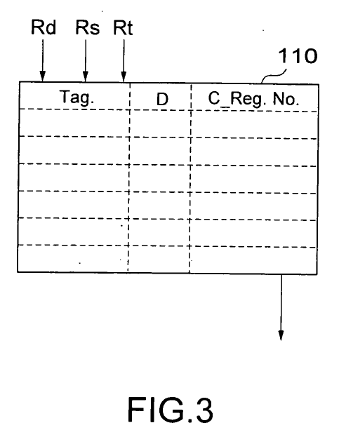

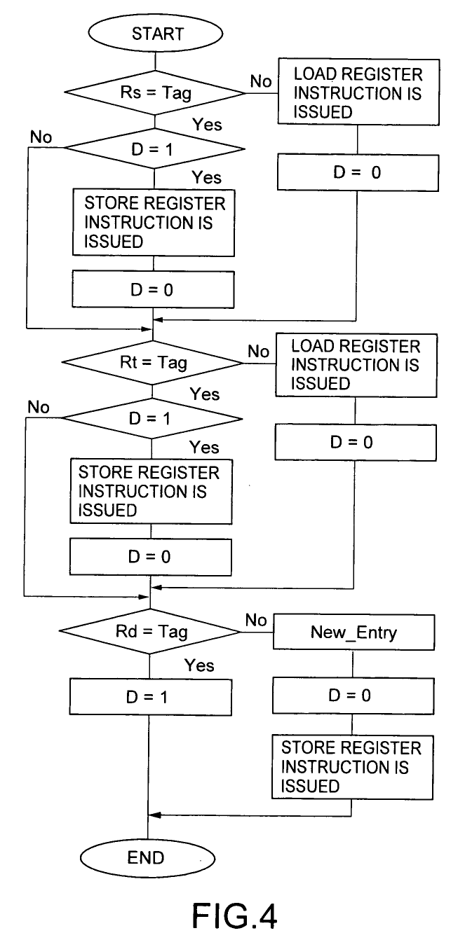

The TAG 110 has information whether a logical register number, which is register-cached in the caching register 300, a caching register number, which is cached, and caching data are in an undesired (dirty) state between the TAG 110 and the RAM 400, on the basis of instruction code information from the instruction fetch 10. FIG. 3 shows the construction of the TAG 110, and FIG. 4 shows the control flow of the TAG 110. In FIG. 2, a logical register is set in a tag region in accordance with the flow of FIG. 3. The register number of the caching register, in which data of a logical register number set in the TAG, is set in a caching register number region (C_Reg. No. in the figure). In the figure, D denotes a flag whether data of the caching register 300 are duty, and it is duty when D=1. The same logical register number as the caching register number is assigned to the initial state of the TAG 110, which is a state that all D=0.

The operation will be described in accordance with the control flow of FIG. 4. First, a source register number is compared with a TAG. If it is not coincidence with the TAG, the source register number is assigned to the TAG in the TAG 110, and the insertion of a load register instruction into a corresponding caching register number is required to the load/store register instruction inserting unit 120. In addition, a corresponding D bit is cleared to 0. If the source register number is compared with the TAG to be coincident therewith, D bit is checked. If D=1, data of a corresponding C_Reg number are in a dirty state, so that the insertion of a store register instruction is required to the load/store register instruction inserting unit 200. Although the above described checking is carried out in order of the source register Rs and Rt in the flow chart of FIG. 4, it may be simultaneously executed.

After the processing to the source register, the destination register number is compared with the TAG. If they are not coincident with each other, D bit is cleared to 0, and the insertion of the store register instruction is required to the load/store register instruction inserting unit 200. If the destination register number is coincident with the TAG, data of the coincident caching register (C_Reg.) are written. Therefore, D=1 is set to be in a duty state, and the routine ends.

In the rewriting of the TAG, data of a caching register number of the lowest frequency of use are rewritten to be returned to an address of the RAM 400 indicated by a logical register by using a generally known replacing algorithm, such as LRU (least-recently used), to assign the caching register number to a newly entered logical register.

By an instruction inserting request produced by the above described flow of processing, the load/store register instruction inserting unit 100 inserts and supplies an insertion instruction, which is required before an intended instruction, to the central window 30 in order of a store register instruction and a load register instruction.

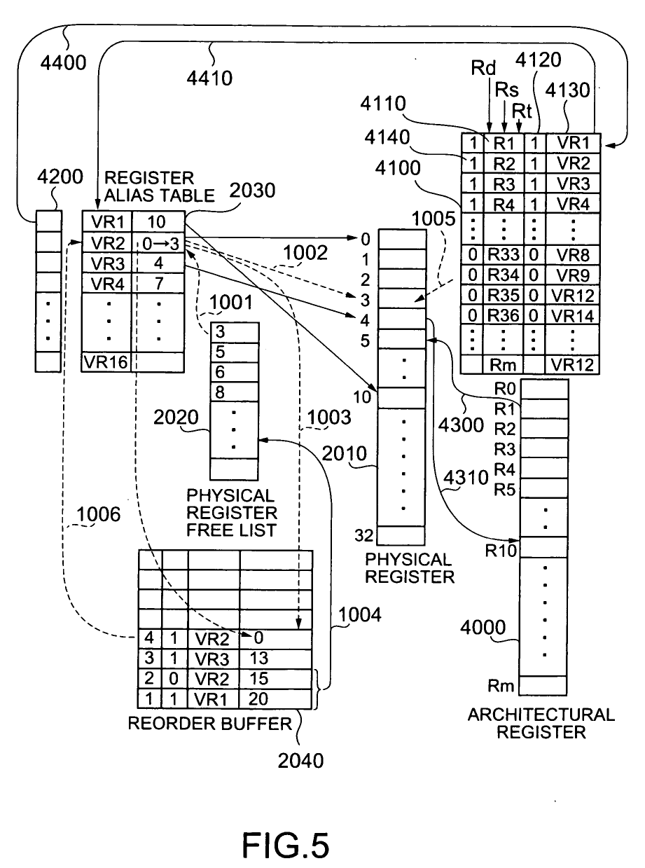

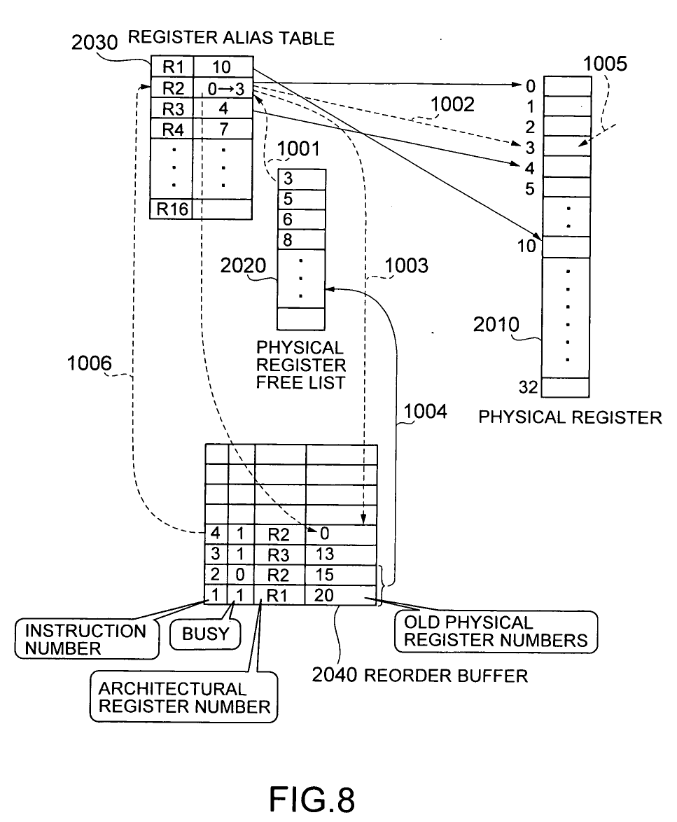

This is the same operation as that of a conventional processor. The consistency of the caching register 300 with the RAM 400 being the register body is taken by the register load instruction/register store instruction insertion. Therefore, it is possible to treat a larger number of logical registers in accordance with conventional controls, such as register renaming processing and out-of-order execution, while preventing pipeline stall from occurring for a long period of time. FIG. 5 shows an example of a construction of a register renaming function wherein the second embodiment of a caching register according to the present invention is provided in the conventional register renaming function shown in FIG. 8.

In FIG. 5, component having the same reference numbers as those in FIG. 8 have the same or similar functions. In the example of FIG. 8, the register alias table 2030 is a table for establishing the correspondence of logical register numbers to physical register numbers. In FIG. 5, the register alias table 2030 is a table for establishing the correspondence of caching register numbers to physical register numbers. However, only the logical register numbers are replaced with the caching register numbers, and the caching register numbers treated by the register alias table 2030 are the same as the conventionally treated logical register numbers.

Therefore, the conventional register alias table 2030 is the same as the register alias table 2030 shown in FIG. 5. Similarly, the processor 2040 and physical register free list 2020 in FIG. 5 have the same construction except that numbers to be treated are changed from the logical register numbers to the caching register numbers.

In FIG. 5, the register alias table 2030, the processor 2040, the physical register free list 2020 and the physical register 2010 have the same construction as that of the register renaming function described in FIG. 8. The operation of these parts is the same as the conventional operation described in FIG. 8, so that descriptions thereof are omitted. In the second embodiment, a logical register 4000, a TAG 4100 and an LRU counter 4200 are provided in addition to the conventional register renaming function.

The TAG 4100 corresponds to the TAG 110 shown in FIG. 3, and comprises a TAG field 4110 for indicating a logical register number, a duty bit 4120, a caching register number field 4130 and a caching register entry bit 4140.

The caching register entry bit 4140 is a bit indicating a logical register currently entered in the caching register. If the caching register entry bit 4140 corresponding to the logical register number of the TAG field 4110 is “1”, it is assumed that the caching register entry bit 4140 has been entered in the caching register.

If the load register instruction described in FIG. 3 is issued, the caching register entry bit 4140 being coincident with the logical register number assigned by the load register instruction is set to “1”. At this time, a caching register number having the lowest access frequency is assigned to the load register instruction. At this time, if the caching register entry bit 4140 is 1 and has been entered in a logical number, which is matched with the caching register number of the caching register number field 4130, i.e., in the caching register, and if the duty bit 4120 of the logical register number to be replaced is “1” and is duty, a store register instruction corresponding to a caching resister number to be assigned is prepared, and the corresponding duty bit 4120 is cleared to 0.

The store register instruction and the load register instruction are issued in that order. Similar to the usual instruction only used for referring to the register to be fetched, the store register instruction refers to the physical register number corresponding to the caching register number of the register alias table 2030 to be prepared as an instruction for storing it in a logical register number to be replaced, and is executed after carrying out a procedure for confirming whether the caching register number corresponding to the processor 2040 has not been entered. If the instruction is executed, data are stored from the physical register 2010 to the destination of the logical register via the signal line 4310.

Similar to the usual instruction for rewriting the register to be fetched, if the subsequent load register instruction assigns a physical register number to the table corresponding to the caching register number of the register alias list 2020 by the physical register free list 2020 to be entered in the processor 2040, data are load in the physical register 2010, which is indicated by the register alias table 2030, from the logical register 4000 via the signal line 4300.

By the above described operation, the caching register is replaced. As described by the flowchart shown in FIG. 4, if the logical registers corresponding to the source register numbers Rs and Rt have been entered in the caching register in the TAG 4100, only the usually fetched instruction is continuously executed by the same operation as the conventional operation without the insertion of the store register instruction and load register instruction.

It is assumed that the assignment of the caching register number carried in the TAG 4100 during the replacement of the caching register is carried out by assigning the caching register number having the lowest access frequency in this embodiment as described above. This can be more simply realized by, e.g., the LRU algorithm using a counter. When the TAG 4100 checks entry of the usually fetched instruction into the caching registers of the source register numbers Rx and Rt, the LRU counter 4200 clears a counter of a hit caching register number to 0, and stores that it was recently accessed.

A smaller counter than a count before clarifying the hit counter is incremented by 1. Other counters remain as they are. Thus, the access frequency of the logical register number entered in each caching register number is relatively indicated, so that the largest caching register number is the caching resister number having the lowest access frequency.

If a program using only half of caching registers is executed and if the caching registers remain in hitting, the remaining half of the caching registers overflow. In such a case, the assignment of caching registers may be carried out on the basis of priority, such as assignment in order of caching register number. If a plurality of caching registers having the maximum counter value exist in case other than overflow, the same method can be used.

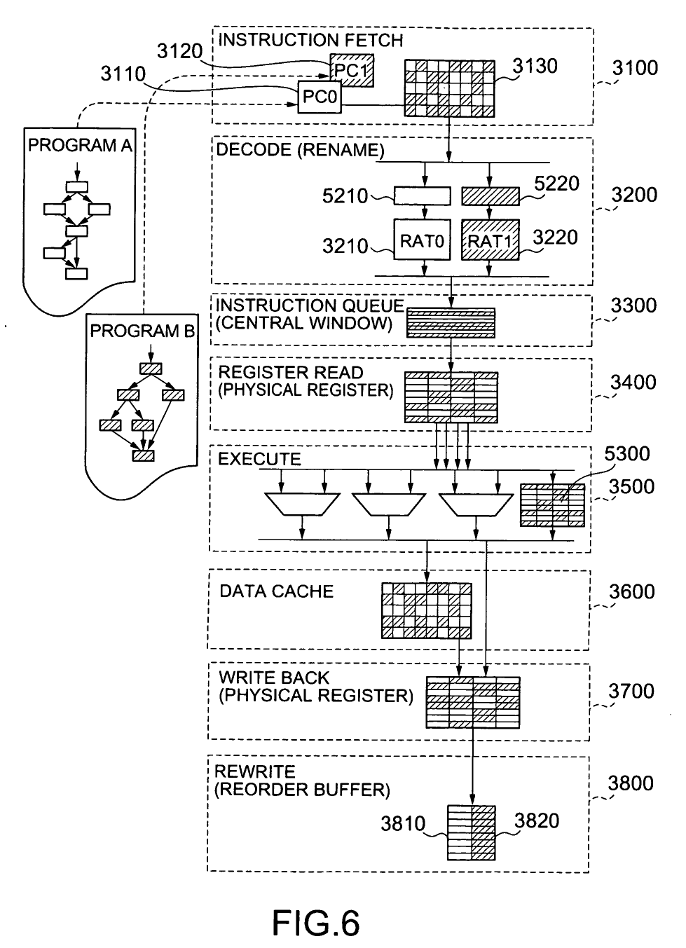

FIG. 6 shows an example of a configuration wherein this embodiment is incorporated in the example of the configuration of the simultaneous multi-threading processor capable of simultaneously executing two threads described in FIG. 9. Similar to the conventional example, the physical register 3400 and the physical register 3700 are shown so as to be divided by operations of register read and register write for convenience of explanation. However, their substance is one register, and corresponds to the physical register 2010 shown in FIG. 5.

Two load/store register instruction inserting units 5210 and 5220 are added to the decoder 3200, and a logical register 5300 is added to the executing unit 3500. The load/store register instruction inserting units 5210 and 5220 correspond to the register alias tables 3210 and 3220, respectively, and the relationship between operations thereof is the same as the operation described in FIG. 5. Objects of logical registers to be cached by the load/store register instruction inserting units 5210 and 5220 are all register numbers mounted in the logical resister 5300, and should be particularly limited.

If a store register instruction is issued from the load/store register instruction inserting unit 5210 or 5220, data are transferred from the physical register 3400 to the logical register 5300. If a load register instruction is issued from the load/store register instruction inserting unit 5210 or 5220, data are transferred from the logical register 5300 to the physical register 3700.

As described in the conventional example, program A and program B are executed without being mutually depend on each other. If a common logical register number is assigned to the programs A and B, access to the same logical register number occurs in the data transfer processing for the store register instruction or load register instruction in this embodiment. This problem is avoided by optimizing the assignment of resisters to each threading program by software by the logical register increased in this embodiment, and by optimizing software due to execution scheduling for each thread.

According to the processor in the second embodiment, the increase of the logical register facilitates the optimization by software. In the second embodiment, a critical factor on operation speed, which causes a problem, is dispersed.

As compared with the processing wherein the arithmetic unit or the like in the executing unit 3500 writes the results after reading and operating data necessary for arithmetic processing, the processing for the store register instruction or load register instruction, which carries out only data transfer, is simple and cause no problem on operation speed. In the conventional example, if the number of logical registers is four times, the size of each register alias table and physical register increases in proportion, and the logical register number field increases, so that there is a jump in the number of signal lines necessary for the connection of the processor 3800 and the decoder 3200.

In the second embodiment, the configuration of each register alias table, physical register and processor is not changed, and the relationship between the addition of the logical register to the executing unit and the register alias table of the load/store register instruction inserting unit in the decoder 3200 is limited to internal signals, so that it is possible to solve the conventional critical problem on operation speed and it is possible to easily increase the number of logical registers.

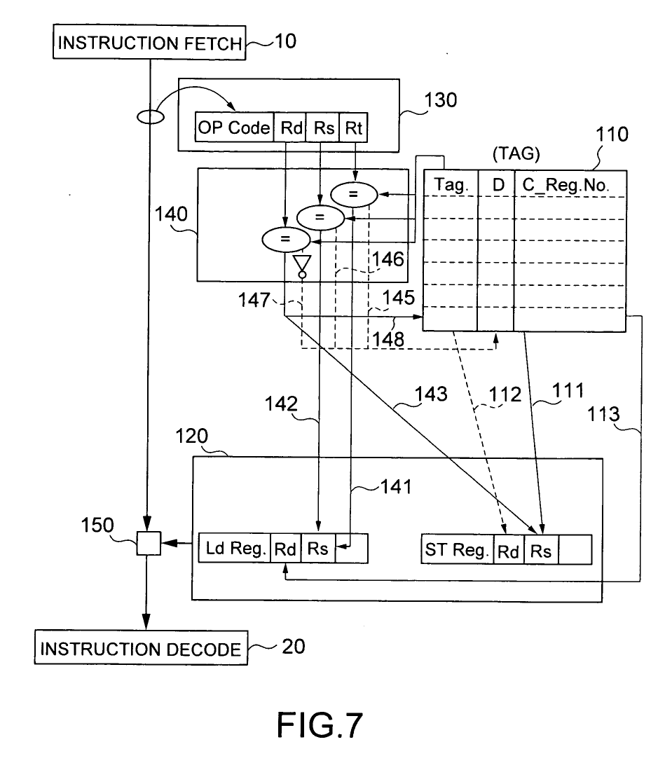

Referring to FIG. 7, the third embodiment of a processor having a register renaming function according to the present invention will be described below. The processor in the third embodiment shows an example of a configuration of a load/store register instruction inserting unit 100 for realizing the control flow of the processor in the second embodiment shown in the flow chart of FIG. 4.

In FIG. 7, the unit 100 comprises a TAG 110, a pre-decoding unit 130 for fetching register number information from an instruction code supplied from the instruction fetch 10, an insertion instruction register number producing unit 140 for comparing the register number information, which is inputted from the pre-decoding unit 130, with a logical register number, which is stored in the tag (Tag.) region of the TAG 110, to produce a register number of an insertion instruction, a load/store register instruction issuing unit 120, and an instruction insertion control unit 150.

The pre-decoding unit 130 fetches register number information from an instruction supplied from the instruction fetch 10, to supplies the fetched register number information to the insertion instruction register number producing unit 140. The insertion instruction register number producing unit 140 compares the logical register numbers, which are stored in the tag (Tag.) region of the TAG 110, on the basis of the supplied register number information. The comparison of the register number information is carried out by the association system with all of the logical register numbers in the tag (Tag.) of the TAG 110 every one of destination register number Rd and source register numbers Rs and Rt.

After the source register numbers Rs and Rt are compared, if they are coincident with each other, D bit of a corresponding TAG 110 is referred. If D=1 being duty, register number information of the store register instruction is supplied to the load/store register instruction issuing unit 120 from the signal lines 111 and 112. In addition, in the same timing as the supply of the register number information of the store register instruction, D bit is cleared via the signal lines 145 and 146. If D=0, nothing is carried out.

If the source register numbers Rs and Rt are not coincident with each other, register number information of the load register instruction is supplied to the load/store register instruction issuing unit 120 from the signal lines 141 and 142, and a caching register number to be loaded by the signal line 113 is supplied to the load/store register instruction issuing unit 120. In addition, the same timing as the supply of the register number information of the load register instruction, D bit of the TAG 110 is cleared via the signal lines 145 and 146.

If the destination register numbers Rd are compared to be coincident with each other, a corresponding D bit in the coincident tag (Tag.) is set to 1 by the signal line 147 to set to be in a duty state. The destination register numbers Rd are not coincident with each other, entry for forcing the TAG 110 out is determined by a replacing algorithm, such as LRU (least-recently used), and register number information corresponding to the determined caching register number is supplied to the load/store register instruction issuing unit 120 via the signal lines 111 and 112 as register number information of the store register instruction. In addition, the destination register number Rd is supplied to the tag (Tag.) of the TAG 110 being an object via the signal line 145.

The load/store register instruction issuing unit 120 has codes in a configuration, such as ROM or PLA, the codes having the same form as that of instruction codes to be fetched, wherein codes indicative of load register (Ld.Reg.) instruction and store register (St.Reg.) instruction are embedded in the operation code part of the instruction code, and prepares an actually issued insertion instruction code by incorporating register number information supplied from the insertion instruction register producing unit 140.

By supplying the register number information corresponding to each of the load register (Ld.Reg.) instruction and store register (St.Reg.) instruction, it is determined whether an instruction must be issued, and the prepared instruction code is issued to the instruction insertion control unit 150. The load register (Ld.Reg.) is not issued unless register information corresponding to the load register (Ld.Reg.) instruction is supplied, and the store register (St.Reg.) is not issued unless register information corresponding to the store register (St.Reg.) instruction is supplied.

If the instruction is issued from the load/store register instruction issuing unit 120, the instruction insertion control unit 150 supplies it to the instruction decode 20 on the basis of the instruction from the load/store register instruction issuing unit 120 before the instruction supplied from the instruction fetch 10. With the above described construction, the operation in the control flow shown in FIG. 4 can be achieved.

What is claimed is:

1. A processor having a register renaming function, comprising:
an instruction fetch part configured to fetch an instruction;
a decoding part configured to decode an instruction code from the instruction fetched by the instruction fetch part;
a register part configured to hold data corresponding to a register number indicated by the instruction code decoded by the decoding part;
a register body configured to hold data corresponding to a register number indicated by said instruction code;
a caching register configured to cache the contents held by said register body;
an inner instruction information holding part configured to hold information on a state of an inner instruction including a logical register number and a caching register number, which are held by said caching register by an instruction from said instruction fetch part;
an instruction insertion determining part configured to compare an instruction code, which is obtained by pre-decoding the instruction from said instruction fetch part, with information on a state of the inner instruction, which is held by said inner instruction information holding part, to determine whether the inner instruction is to be inserted; and
a register transfer instruction issuing part configured to issue a register transfer instruction for transferring inner data between said caching register and said register body when said instruction insertion determining part determines that the inner transfer instruction is to be inserted,
thereby the processor having a register renaming function for sequentially rewriting the contents of a register alias table using a reorder buffer and a physical register free list, said reorder buffer holding a correspondence of a logical register number to its physical register number, which are included in the decoded instruction code, in a register alias table and storing an assignable number of the physical register number in the physical register free list to store a correspondence of an instruction number, an architecture register number and an old physical register number.

2. A processor having a register renaming function as set forth in claim 1, wherein said register body comprises a logical register capable of being referred on a program, and said caching register comprises an inner register configured to hold a part of said logical register, said register transfer instruction issuing part comprising a converting part for converting it into an inner register number, which is used by said logical register and said inner register, and a code producing part configured to produce a code in the same form as that of a processor inner instruction code for transferring data between said logical register and said inner register.

3. A processor having a register renaming function as set forth in claim 1, which further comprises a pre-decoding part configured to pre-decode an instruction from said instruction fetch part to an instruction code.

4. A processor having a register renaming function as set forth in claim 3, wherein a register instruction inserting unit is configured to insert a load register instruction and a store resister instruction by said pre-decoding part, said instruction insertion determining part and said register transfer instruction issuing part, to issue an instruction.

5. A processor having a register renaming function as set forth in claim 4, wherein said register instruction insertion unit comprises: an inner instruction holding part configured to hold said inner instruction information; a pre-decoding part configured to fetch register number information from an instruction code supplied from said instruction fetch part; an insertion instruction register number producing part as said instruction insertion determining part configured to compare said register number information, which is supplied from said pre-decoding part, with a logical register number, which is stored in a TAG region of the inner instruction information held by said inner instruction holding part, to produce a register number of an insertion instruction; and a load/store register instruction issuing part as said register transfer instruction issuing part configured to issue a load/store register instruction on the basis of the register number of said insertion instruction produced by the insertion instruction register number producing part.

6. A processor having a register renaming function as set forth in claim 5, which further comprises an instruction insertion control part configured to add an instruction from said load/store register instruction issuing part before the instruction supplied from said instruction fetch part, to the added instruction to said instruction decoding part on the basis of said load/store register instruction issuing part, said instruction insertion control part being provided between said instruction fetch part and said instruction decoding part.

7. A processor having a register renaming function, comprising:
an instruction fetch part configured to fetch an instruction;
a decoding part configured to decode an instruction code from the instruction fetched by the instruction fetch part;
a register part configured to hold data corresponding to a register number indicated by the instruction code decoded by the decoding part;
a register body configured to hold data corresponding to a register number indicated by said instruction code, and including a logical register capable of being referred on a program;
a caching register configured to cache the contents held by said register body, and including an inner register configured to hold a part of said logical register;
an inner instruction information holding part configured to hold information on a state of an inner instruction including a logical register number and a caching register number, which are held by said caching register by an instruction from said instruction fetch part;
an instruction insertion determining part configured to compare an instruction code, which is obtained by pre-decoding the instruction from said instruction fetch part, with information on a state of the inner instruction, which is held by said inner instruction information holding part, to determine whether the inner instruction is to be inserted; and
a register transfer instruction issuing part configured to issue a register transfer instruction for transferring inner data between said caching register and said register body when said instruction insertion determining part determines that the inner transfer instruction is to be inserted, and comprising a converting part configured to convert it into an inner register number, which is used by said logical register and said inner register, and a code producing part configured to produce a code in the same form as that of a processor inner instruction code for transferring data between said logical register and said inner register,
thereby the processor having a register renaming function for sequentially rewriting the contents of a register alias table using a reorder buffer and a physical register free list, said reorder buffer holding a correspondence of a logical register number to its physical register number, which are included in the decoded instruction code, in a register alias table and storing an assignable number of the physical register number in the physical register free list to store a correspondence of an instruction number, an architecture register number and an old physical register number.

8. A processor having a register renaming function as set forth in claim 7, which further comprises a pre-decoding part configured to pre-decode an instruction from said instruction fetch part to an instruction code.

9. A processor having a register renaming function as set forth in claim 8, wherein a register instruction inserting unit is configured to insert a load register instruction and a store resister instruction by said pre-decoding part, said instruction insertion determining part and said register transfer instruction issuing part, to issue an instruction.

10. A processor having a register renaming function as set forth in claim 9, wherein said register instruction insertion unit comprises: an inner instruction holding part configured to hold said inner instruction information; a pre-decoding part configured to fetch register number information from an instruction code supplied from said instruction fetch part; an insertion instruction register number producing part as said instruction insertion determining part configured to compare said register number information, which is supplied from said pre-decoding part, with a logical register number, which is stored in a TAG region of the inner instruction information held by said inner instruction holding part, to produce a register number of an insertion instruction; and a load/store register instruction issuing part as said register transfer instruction issuing part configured to issue a load/store register instruction on the basis of the register number of said insertion instruction produced by the insertion instruction register number producing part.

11. A processor having a register renaming function as set forth in claim 10, which further comprises an instruction insertion control part configured to add an instruction from said load/store register instruction issuing part before the instruction supplied from said instruction fetch part, to the added instruction to said instruction decoding part on the basis of said load/store register instruction issuing part, said instruction insertion control part being provided between said instruction fetch part and said instruction decoding part.

12. A processor having a register renaming function, comprising:
an instruction fetch part configured to fetch an instruction;
a decoding part configured to decode an instruction code from the instruction fetched by the instruction fetch part;
a register part configured to hold data corresponding to a register number indicated by the instruction code decoded by the decoding part;
a register body configured to hold data corresponding to a register number indicated by said instruction code.;
a caching register configured to cache the contents held by said register body;
an inner instruction information holding part configured to hold information on a state of an inner instruction including a logical register number and a caching register number, which are held by said caching register by an instruction from said instruction fetch part;
an instruction insertion determining part configured to compare an instruction code, which is obtained by pre-decoding the instruction from said instruction fetch part, with information on a state of the inner instruction, which is held by said inner instruction information holding part, to determine whether the inner instruction is to be inserted;
a register transfer instruction issuing part configured to issue a register transfer instruction for transferring inner data between said caching register and said register body when said instruction insertion determining part determines that the inner transfer instruction is to be inserted; and
a pre-decoding part configured to pre-decode an instruction from said instruction fetch part to an instruction code,
thereby the processor having a register renaming function for sequentially rewriting the contents of a register alias table using a reorder buffer and a physical register free list, said reorder buffer holding a correspondence of a logical register number to its physical register number, which are included in the decoded instruction code, in a register alias table and storing an assignable number of the physical register number in the physical register free list to store a correspondence of an instruction number, an architecture register number and an old physical register number.

13. A processor having a register renaming function as set forth in claim 12, wherein said register body comprises a logical register capable of being referred on a program, and said caching register comprises an inner register for holding a part of said logical register, said register transfer instruction issuing part comprising a converting part for converting it into an inner register number, which is used by said logical register and said inner register, and a code producing part for producing a code in the same form as that of a processor inner instruction code for transferring data between said logical register and said inner register.

14. A processor having a register renaming function as set forth in claim 13, wherein a register instruction inserting unit is configured to insert a load register instruction and a store resister instruction by said pre-decoding part, said instruction insertion determining part and said register transfer instruction issuing part, to issue an instruction.

15. A processor having a register renaming function as set forth in claim 14, wherein said register instruction insertion unit comprises: an inner instruction holding part configured to hold said inner instruction information; a pre-decoding part configured to fetch register number information from an instruction code supplied from said instruction fetch part; an insertion instruction register number producing part as said instruction insertion determining part configured to compare said register number information, which is supplied from said pre-decoding part, with a logical register number, which is stored in a TAG region of the inner instruction information held by said inner instruction holding part, to produce a register number of an insertion instruction; and a load/store register instruction issuing part as said register transfer instruction issuing part configured to issue a load/store register instruction on the basis of the register number of said insertion instruction produced by the insertion instruction register number producing part.

16. A processor having a register renaming function as set forth in claim 15, which further comprises an instruction insertion control part configured to add an instruction from said load/store register instruction issuing part before the instruction supplied from said instruction fetch part, to the added instruction to said instruction decoding part on the basis of said load/store register instruction issuing part, said instruction insertion control part being provided between said instruction fetch part and said instruction decoding part.
